(19) United States
(12) Patent Application Publication
(10) Pub. No.: US 2014/0088785 A1
(43) Pub. Date: Mar. 27, 2014

(54) MANAGEMENT OF THE ENERGY SUPPLY FOR A LOCAL ENERGY TRANSPORT NETWORK

(71) Applicants: Laurent Massoulie, Vaucresson (FR); Srinivasan Keshav, Waterloo (CA); Nidhi Hegde, Paris (FR); Theodoros Salonidis, New York, NY (US)

(72) Inventors: Laurent Massoulie, Vaucresson (FR); Srinivasan Keshav, Waterloo (CA); Nidhi Hegde, Paris (FR); Theodoros Salonidis, New York, NY (US)

(73) Assignee: THOMSON LICENSING, Issy de Moulineaux (FR)

(21) Appl. No.: 13/980,971

(22) PCT Filed: Jan. 24, 2012
(86) PCT No.: PCT/EP12/51028

§ 371 Date: Dec. 10, 2013

(30) Foreign Application Priority Data
Jan. 25, 2011 (EP) 11305073.6

(51) Int. Cl. G06F 1/32; H02J 9/00

(52) U.S. Cl. CPC G06F 1/32; H02J 9/00
USPC 700/296; 307/66

(57) ABSTRACT

The invention relates to a system for managing the supply of energy of a client device connected to an energy transport network, said system comprising a switching device connected to said network, said system comprising an energy storage means connected to said network via the switching device, wherein the switching device is able to be configured according to three configuration modes, the system also comprising a control device comprising means for comparing a level of energy stored in the storage means and a local threshold of charge of the storage means and means for determining and assigning to the switching device a configuration mode from among the three configuration modes according to the result of said comparison.

### FIELD OF THE INVENTION

The invention relates to the management of the supply of energy of a local energy transport network. The invention relates more specifically to a method and a system for managing the supply of energy to such a network and a control device of said system.

### PRIOR ART

The issue of the management of the supply of energy of individual energy networks is increasingly critical as evidenced by recent developments in smart grids.

At the level of of individual energy networks, in recent years there has been a rapid development of energy supply systems based notably on the use of photo-voltaic panels covering the roofs of dwellings. These panels provide cheap and renewable electrical energy when they are illuminated by the sun that is to say at a time when the domestic network is consuming little energy. In general, these systems therefore comprise a means for storing the energy allowing deferred use of energy notably at times when the sun is down and when the energy needs of dwellings is higher. Moreover, it is likely that in a few years, the use of electric vehicles will be developed and that the batteries of these vehicles will provide substantial additional energy storage capacity when parked close to said dwellings.

Nowadays, the management of these energy storage means is very rudimentary: it aims mainly to absorb the excess energy produced during the day from individual devices such as photo-voltaic panels. This management method is suitable for dwellings to which an operator supplies energy at a constant price regardless of the time of day.

However, we are seeing a change in pricing practices by operators supplying energy to individuals. These operators modulate the price of the energy supplied according to the time when the energy is supplied and therefore consumed. This modulation is currently very simple: thus in France, the tariff schedule of ElectricitO de France (EDF) comprises a first price called “Heures creuses HC” (“off-peak times”) and a second price called “Heures pleines HP” (“peak times”). The price of a kilowatt-hour during “off-peak times” is lower than the price of a kilowatt-hour during “peak times”. The “off-peak times” correspond to the periods of the day when EDF has observed that the overall demand for electrical energy in the French territory (individual and industrial consumption) is lower: for example, from 10 p.m. to 6 a.m., and “peak times” are from 6 a.m. to 10 p.m. This tariff schedule has the double advantage of allowing EDF to reduce recourse to additional energy sources (thermal power plants) to compensate for peaks in energy demand by distributing energy demand and allowing consumers to reduce their electric bill if they turn on their electrical equipment during time slots when energy is cheaper such as during the “off-peak times.”

In fact, the additional energy sources are considered to be more expensive and more harmful to the environment than conventional energy sources such as nuclear power plants.

Simple, incentive tariff schedules have the particular advantage of being easily adopted by consumers who can choose the night, for example, to turn on their high energy-consumption equipment (washing machine, etc.).

Some of the equipment connected to domestic electrical networks comprise devices controlling their start-up during periods corresponding to “off-peak times.” However it is clear that this type of tariff incentive forces the individual consumer to choose a time for consumption of electrical energy. This constraint can be difficult to bear due to the noise pollution that delayed consumption can produce (for example, the noise produced by the rotation of a washing machine drum) or due to the nature of equipment whose start-up cannot be delayed (electric heating).

In addition, in the future, to encourage even more individuals to consume energy at times of their choice, it is likely that energy supply companies will refine their tariff schedules and that these ones will comprise more than one division of the day into two complementary time periods. The trend is therefore a shift in the definition of tariff schedules with a fine temporal granularity (from one to several hours) which would also be likely to change both in terms of the definition of the time periods and the prices charged during these time periods over varying time frames (monthly or annually). Delayed start-up programming systems for equipment are not suited to this growing complexity of energy tariff schedules.

The purpose of the present invention is to reduce the bill for the supply of energy of a domestic electrical network by taking advantage of new energy storage means available in individual households while avoiding the growing complexity of energy tariff schedules adapted by the energy supply operators.

### SUMMARY OF THE INVENTION

It is noted that it is more worthwhile from an economic standpoint to consume the energy stored preferentially when the price of the energy supplied by the operator is high and to charge the storage means PSD with energy preferably when the price of the energy supplied is low. The present invention proposes an automatic and adaptive method and system for managing the supply of energy to reduce the bill for the energy supplied based on the above observation.

“Automatic” is understood to mean that the method and the system proposed do not require manual configuration (i.e. by a human operator), for example to set price thresholds in connection with a tariff schedule modified by the energy supply operator. In particular, the invention is adapted to tariff modifications of the energy supply operator over time.

“Adaptive” here meaning that the method and the system proposed evaluate the energy bill continuously in time according to the total level of energy supplied (including the level of energy consumed directly by the client device plus, if it exists, the level of energy stored in the storage means) and the time of the supply of this level of energy.

The idea behind the invention is, knowing the tariff schedule of an energy supply operator, preferentially to store the energy supplied by the operator during the time periods when the price of energy is cheap and preferentially to consume the energy stored in the energy storage means during periods when the price of the energy supplied by the operator is higher.

To this end, an object of the invention is, according to a first aspect, a system for managing the supply of energy of a client device connected to a local energy transport network, said system comprising a switching device connected to said network, the client device being able to be supplied with energy via the switching device,

an operator supplying energy to said network according to a tariff schedule according to which the time is decomposed into successive time cycles, each time cycle being divided into a number m greater than or equal to 2 of successive time periods during each of which said energy is billed at a price corresponding to said period,
said system comprising an energy storage means connected to said network via the switching device,
wherein the switching device is able to be configured according to:
a first configuration mode wherein the energy storage means supplies energy to the client device; or
a second configuration mode wherein the operator supplies energy simultaneously to the client device and to the energy storage means; or
a third configuration mode wherein the operator supplies energy exclusively to the client device.

Said system also comprises a control device comprising means for comparing an instantaneous level of energy stored in the storage means and a local threshold of charge of the storage means associated with each time period and means for determining and assigning to the switching device a configuration mode from among the first, second and third configuration modes according to the result of said comparison.

Advantageously, the control device comprises means for comparing the instantaneous level of energy stored in the storage means at the start of the time period and a first and a second current thresholds of charge of the storage means associated with each time period and means for determining the local threshold from the result of said comparison.

Advantageously, the means for determining and assigning are able to determine and assign to the switching device when the client device (DCL) requires energy:
the first mode when the instantaneous level of energy is strictly greater than the local threshold;
the second mode when the instantaneous level of energy is strictly less than the local threshold;
the third mode when the instantaneous level of energy is equal to the local threshold.

Advantageously, the switching device is able to deliver to the control device at the end of each time period a first level of energy supplied by the operator to the client device and a second level of energy supplied by the operator to the energy storage means during said time period.

Advantageously, the control device is adapted to determine a first vector of n elements (p₁, . . . , pᵢ, . . . , pₙ) which correspond to the energy prices of the tariff schedule classified according to an increasing order, and two second vectors of n elements which are thresholds of charge of the storage means associated with the prices (p₁, . . . , pᵢ, . . . , pₙ) where i is an integer comprised between 1 and n, the control device also being adapted to determine the first and second current thresholds from the first and second vectors and from said tariff schedule.

Advantageously, the control device comprises means for updating, at the end of each time cycle, the value of the elements of the two second vectors from a result of comparison between a real cost of the supply by the operator of a total level of energy and 2n fictitious costs, where the total level is equal to the sum of the first level of energy and the second level of energy during said time periods and where the fictitious costs result from 2n simulations peformed by the device of the cost of a supply of energy by the operator to said system, by considering a level of energy supplied by the operator to the client device during said time periods equal to the first level of energy and by successively considering 2n associations composed of the first vector and of a fictitious second vector where the fictitious second vector comprises n elements (LTL₁, . . . , LTLᵢ+δ, . . . LTLₙ) and the fictitious second vector comprises n elements (HTL₁, . . . , HTLᵢ+δ, . . . , HTLₙ), where δ is a positive integer stored in the control device (GWY).

Advantageously, the switching device is also able to be configured according to:
a fourth mode wherein the operator supplies energy only to the energy storage means;
a fifth mode wherein the operator does not supply energy to the system;
   and when the client device does not require the energy, the means for determining and assigning of the control device are able to determine and assign to the switching device:
the fourth mode if the instantaneous level of energy is strictly less than the local threshold;
the fifth mode if the instantaneous level of energy is greater than or equal to the local threshold.

An object of the invention is, according to a second aspect, a control device for a system for managing the supply of energy of a client device connected to a local energy transport network, the client device being able to be supplied with energy via a switching device connected to said network, an operator supplying energy to said network according to a tariff schedule according to which the time is decomposed into successive time cycles, each time cycle being divided into a number m greater than or equal to 2 of successive time periods during each of which said energy is billed at a price corresponding to said period.

The control device comprises:
a first means for receiving from the switching device at the end of each time period a first level of energy supplied by the operator to the client device and a second level of energy supplied by the operator to the energy storage means during said time period;
a second means which comprises an association of a first vector of n elements (p₁, . . . , pᵢ, . . . , pₙ) corresponding to the energy prices of the tariff schedule classified according to an increasing order and two second vectors each comprising n elements which are thresholds of charge of the storage means associated with the prices (p₁, . . . , pᵢ, . . . , Pₙ), where i is an integer comprised between 1 and n, said second means also being configured to determine a first and a second current threshold of charge from said association and from said tariff schedule, said means also being adapted to determine a local threshold of charge of the storage means from a comparison between an instantaneous level of energy stored in the means at the time period start and said first and second current thresholds of charge associated with said time period;
a third means for determining and assigning in real time a configuration mode to the switching device on the basis of a comparison between:
   the instantaneous level which said third means is able to receive in real time from said storage means; and
   the value of the local threshold associated with said time period.

An object of the invention is, according to a third aspect, a method for managing the supply of energy of a client device connected to a local energy transport network, the device being able to require energy via a switching device connected to said network, an operator supplying energy to said network via said device according to a tariff schedule according to which the time is decomposed into successive time cycles, each time cycle being divided into a number m greater than or equal to 2 of successive time periods during each of which said energy is billed at a price corresponding to said period, an energy storage means being connected to said network via the switching device configured according to a first mode wherein the means supplies energy to the client device or a second mode wherein the operator supplies energy simultaneously to the client device and to the energy storage means, or a third mode wherein the operator supplies energy exclusively to the client device.

At the control device, the method comprises the steps of:
receiving said tariff schedule;
continuously and in real time, receiving from the energy storage means an instantaneous level of energy stored in said energy storage means;
evaluating a number n of elements of a first vector from said tariff schedule and at the start of each time cycle determining n elements of two second vectors associated with n elements of the first vector;
determining a first and a second current thresholds of charge of the storage means for said current period from the tariff schedule and from the association;
at each time period:
   determining an instantaneous level of energy at the start of the time period;
   determining a local threshold of charge of the storage means (PSD) from a comparison between the instantaneous level of energy stored in the storage means at the start of the time period and the first and second current thresholds of charge associated with the time period;
continuously and in real time, determining and assigning a configuration mode to the switching device in such a manner that the instantaneous level meets the local threshold.

According to an embodiment of the invention, the method comprises the steps of:
evaluating the real cost of the supply of energy by the operator during said time cycle covering said time periods;
evaluating 2n fictitious costs of the supply of energy by the operator during said time cycle covering said time periods from an evaluation of two sets of n second costs of the supply of energy by the operator to the energy storage means during said time period by considering a level of energy supplied by the operator to the client device during said time periods equal to the first level of energy, by successively considering 2n associations composed of the first vector and of a fictitious second vector where the fictitious second vector comprises n elements (LTL₁, . . . , LTL₁+δ, . . . , LTLₙ) and the fictitious second vector comprises n elements (HTL₁, . . . , HTLᵢ+δ, . . . , HTLₙ), where δ is a positive integer stored in the control device;
comparing at the end of the time cycle the value of the real cost and the value of each of the fictitious costs;
updating the value of the elements of the second vectors stored in the control means according to the results of said comparisons.

### BRIEF DESCRIPTION OF THE DRAWINGS

The invention will be better understood upon reading the following detailed description of an example embodiment of the invention. This description is provided only as an example and refers to the annexed drawings wherein:

FIG. 1 shows a system for managing the electrical supply of a local energy transport network according to an embodiment of the invention;

FIGS. 2a, 2b, 2c, 2d, 2e show the flows of energy in said management system when the switching device COM which it comprises is respectively configured according to a first, a second, a third and a fourth mode;

FIG. 3 shows the temporal change over a duration of a time cycle C1 of the instantaneous level SEL of energy stored in the energy storage means PSD of the system according to the embodiment of the invention;

FIG. 4 shows the temporal change of the current thresholds of charge QTL_{T1}, QTL_{T2}, QTL_{T3}, QTL_{T4′}, QTL_{T1′}, QTL_{T2′}, QTL_{T3′}, QTL_{T4′}, over a duration corresponding to two successive time cycles C1, C2;

FIG. 5 shows diagrammatically an example of the architecture of a control device GWY according to an embodiment of the invention;

FIG. 6a shows the value of local threshold QTL_{T1} of charge determined by the device GWY for a particular embodiment of the invention where a single threshold TL_{T1} is associated with the price q_{T1} of the energy supplied during the time period T₁;

In addition, FIG. 6b shows the values of local threshold QTL_{T1} of charge determined by the device GWY according to the instantaneous level SEL_{INIT,T1} of energy stored in the storage means PSD at the start of the time period T₁ for an embodiment of the invention where two thresholds LTL_{T1}, HTL_{T1} are associated with the price _{qTl} of the energy supplied during the time period T₁.

FIG. 7 shows a flowchart of a method according to the embodiment of the invention where two thresholds LTL_{T1}, HTL_{T1} are associated with the price q_{T1} of the energy supplied during the time period T₁.

### DETAILED DESCRIPTION OF PREFERRED EMBODIMENTS

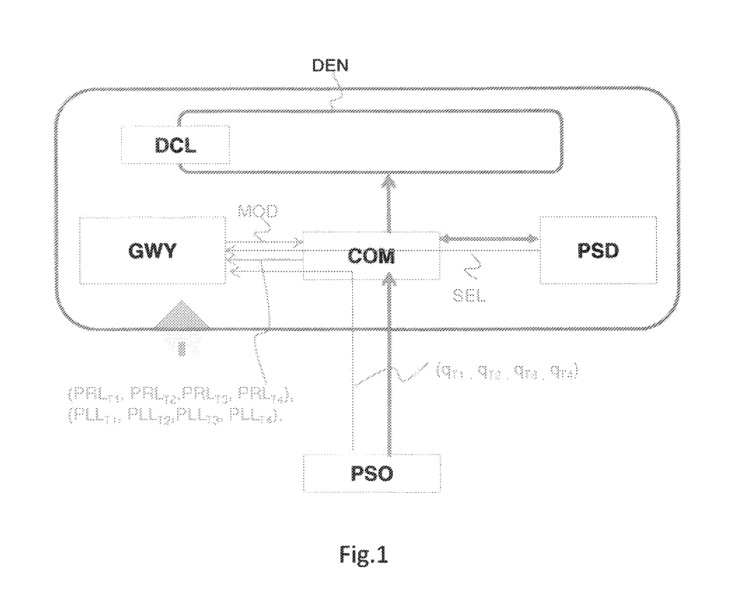

FIG. 1 shows a local energy transport network DEN comprising at least one client device DCL configured to consume the energy carried on said network DEN.

By “local energy transport network” is understood an energy transport network wherein the energy access is centralized on a particular node where a switching device COM may be placed. This switching device COM is configured to control the supply of energy of the whole local network DEN.

The network DEN equips for example an individual dwelling unit: this is then referred to as a domestic network. However, the local energy transport networks DEN are not restricted to domestic networks only and can also equip industrial production units: for example a building comprising an item of equipment for industrial use functioning using energy supplied by an energy source external to the network DEN.

In the description which follows, the network DEN is a local electricity transport network. But it goes without saying that the embodiment of the invention is not restricted to managing the supply of electricity of local electricity transport networks.

Returning to the elements of FIG. 1: an energy storage means PSD is connected to the network DEN via the device COM. Thus, the client device DCL which is connected to the electrical network DEN can be supplied with electrical energy either by the electricity stored in the energy storage means PSD or by electricity directly supplied by an energy supply operator PSO: for example electricity from an electrical energy source external to the network DEN. The origin of the electricity consumed by the device DCL is defined by the configuration mode of the device COM.

For example, placed in a particular configuration mode, the switching device COM can authorize an operator PSO to supply energy to client devices connected to the network DEN by an energy source external to the local network. Placed in another particular configuration mode, the switching device COM can also block the supply of energy of the network DEN by the operator PSO and transform the energy storage means into an energy source for the client devices connected to the network DEN.

The storage means PSD is preferentially a fixed means linked to the dwelling unit. But it can also comprise mobile parts such as for example an electric battery of a motor vehicle offering an energy storage capacity only when the vehicle is parked close to the dwelling and when the battery of the vehicle is connected to the local network via the device COM.

In the remainder of the description, it will be assumed that the operator PSO is the only electricity supplier of the network and that it supplies electricity from a single external source to the network DEN. The energy produced by said source is conveyed to the network by the operator PSO. The energy stored in the storage means PSD can also be supplied beforehand by the operator PSO and also comes from said source EPS. The energy source is for example a nuclear energy power plant. It goes without saying that the energy supplied by the operator PSO can be produced by several sources simultaneously.

In what follows, it will be considered that the operator PSO has an infinite capacity to supply electrical energy: that is to say that the operator PSO can, without limitation, manage to supply as much energy as the client device or devices DCL of the network DEN require(s) and, if necessary, simultaneously also charge the energy storage means PSD with energy.

For its part, the storage means PSD has a finite and determined storage capacity CAP. In other words, the storage means PSD can continue to store energy until the instantaneous level SEL of energy which it contains does not exceed CAP. Moreover, the storage means PSD constitutes an energy source for supplying the network DEN while the instantaneous level SEL of energy which it contains is greater than 0.

The energy source and the storage means PSD are both connected to the network DEN via the switching device COM which can be configured according to:

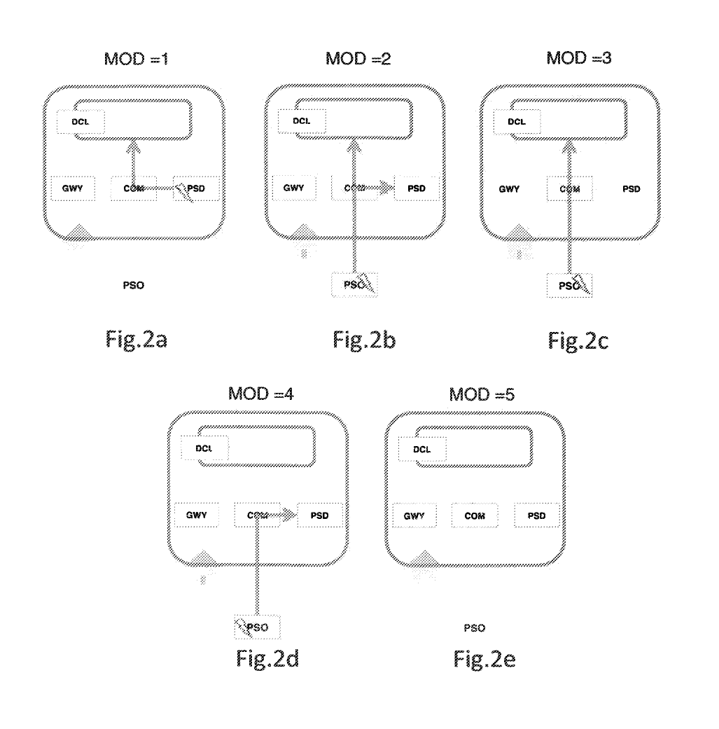

A first mode, shown diagrammatically in FIG. 2a, wherein the energy storage means PSD supplies only the client device DCL with the energy which it contains via the switching device COM; or

A second mode, shown diagrammatically in FIG. 2b, wherein the operator PSO supplies energy to the client device DCL and simultaneously charges with energy (that is to say supplies with energy) the storage means PSD via the switching device COM; or

A third mode, shown diagrammatically in FIG. 2c, wherein the operator PSO supplies energy exclusively to the client device DCL; or

A fourth mode, shown diagrammatically in FIG. 2d, wherein, only the energy storage means PSD is charged with energy by the external source via the switching device COM; or

A fifth mode, shown diagrammatically in FIG. 2e, wherein, the client device DCL is not supplied with energy and the energy storage means PSD is not charged with energy by the source EPS.

In FIG. 1, the thin arrows represent the flows of information. In FIGS. 2a, 2b and 2c, the bold arrows represent a flow of energy.

In FIGS. 2a, 2b, and 2c, a lightning bolt represents the energy source supplying the client device DCL.

A control device GWY determines the configuration mode from among the first, second, third, fourth or fifth mode from an information on the current level of charge SEL of the storage means PSD (which it will also be possible to describe later as the value of the instantaneous level SEL of energy stored in the storage means PSD) and from a local threshold of charge information which corresponds to a target charge of the storage means PSD. The control device GWY assigns to the switching device COM the configuration mode which it determines. This determining and assigning are performed in real time, that is to say at the rate at which the device GWY receives the information on the current level of charge SEL of the storage means PSD.

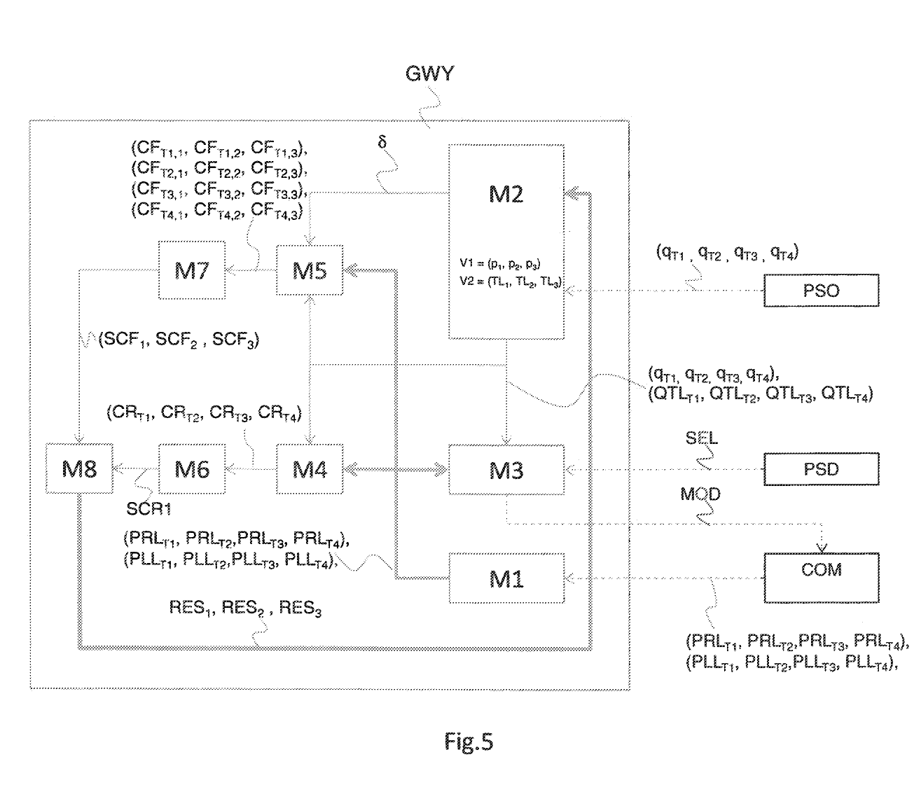

More specifically, as shown in FIG. 5, the control device GWY comprises a means M3 which determines the configuration mode MOD of the switching device COM in such a way that the instantaneous level SEL of the energy stored in the storage means is greater than or equal to a local threshold of charge which corresponds to a level of energy stored in the storage means which is a target level. The way in which the configuration modes of the device COM are determined by the control device GWY will be specified later in the description.

One of the particular aspects of the invention is that the local threshold of charge of the energy storage means PSD is not constant in time and takes a value which is linked to the price of the energy likely to be supplied by the operator PSO at that time.

In the rest of this document, a first part describes a first embodiment of the invention wherein a single threshold is associated with each price of energy supplied by the operator PSO.

Based on this first description, a second embodiment will then be presented for which two thresholds are associated with each price of energy supplied by the operator PSO.

The first embodiment described is of course a particular case of the second embodiment and corresponds to a situation in which the two thresholds have equal values. It would appear simpler to explain the details of the first embodiment before starting the explanation of the second embodiment. This is all the more justified as it should be noted that the step for calculating fictitious costs of the second embodiment of the invention is identical to the similar step of the first embodiment as will be shown later.

In what follows, an energy supply operator PSO will be considered which bills the supply of energy according to a tariff schedule which breaks down the time into periodic, successive and preferably identical time cycles C1, C2. A time cycle C1, C2 is divided into a number m of successive time periods T₁, . . . , Tⱼ, . . . , Tₘ during which the energy which the operator PSO supplies is billed at the price q_{T1}, . . . , q_{Tj}, . . . , q_{Tm}.

To illustrate the invention in a simple manner, time cycles C1, C2 with durations corresponding to 24 hours are considered. The time cycle C1 is divided into a number m=4 of successive time periods T₁, T₂, T₃, T₄ during which the price of the energy supplied by the operator PSO is fixed and respectively equal to q_{T1}, q_{T2}, q_{T3}, q_{T4}.

q_{T1}, q_{T2}, q_{T3}, q_{T4} constitutes a tariff schedule of the operator which indicates the price at which the energy supplied during the time periods T₁, T₂, T₃, T₄ is billed. This tariff schedule applies to all successive time cycles. Thus, the variation in the amount billed from one time cycle to another only depends on the level of energy supplied by the operator PSO and on the time period T₁, T₂, T₃, T₄ during which this supply takes place.

Again for the purpose of describing the embodiment of the invention in a simple manner, it is considered that the 4 time periods T₁, T₂, T₃, T₄ each have an equal duration of 6 hours during which the price of the energy billed is equal to (q_{T1}, q_{T2}, q_{T3}, q_{T4})=(1, 10, 50, 10).

It goes without saying that the method and the system proposed can operate with a cycle duration different from 24 hours and also a number m of periods different from 4 provided it is greater than 2. The duration of the time periods has no effect.

In addition, the method according to the invention enables the energy bill to be reduced all the more significantly since the tariff schedule remains unchanged over several successive time cycles. It also enables adaptation to changes in the tariff schedule by the operator PSO, as will be explained later.

At the start of a first time cycle C1, and after the reception by the control device GWY of the tariff schedule q_{T1}, q_{T2}, q_{T3}, q_{T4}, a first vector V1 is constituted. The first vector V1 comprises n elements p₁, . . . , pᵢ, . . . , pₙ which correspond to the energy prices figuring in the tariff schedule. The elements p, are classified in increasing order. It is assumed that n is an integer greater than or equal to 2, that is to say that the tariff schedule comprises at least two different prices. n is naturally a number less than or equal to m as a price can be used for two different time periods and for i comprised between 1 and n−1, pᵢ is less than pᵢ₊₁.

The first vector V1 is stored in a means M2 of the control device GWY shown in FIG. 5.

In our example, n=3 as 3 different prices are included in the tariff schedule q_{T1}, q_{T2}, q_{T3}, q_{T4} and the first vector V1 is (1, 10, 50).

As long as the tariff schedule is not modified (for example by a modification of one of the prices q_{Tj} figuring in the tariff schedule q_{T1}, q_{T2}, q_{T3}, q_{T4} by a deletion or an addition of a time period which it comprises), the value of the elements of the first vector V1 is not modified.

Description specific to the first embodiment of the invention wherein a single threshold of charge TLᵢ is associated with a price pᵢ of the energy supplied by the operator PSO.

We place ourselves in a situation where two second vectors V2L and V2L presented in a second part of the present document are equal: a single second vector denoted V2 will be considered in this first part of the description rather than two vectors V2H and V2L which have the same value.

The second vector V2 is constituted at the start of the time cycle by the means M2. It comprises n=3 elements (TL₁, TL₂, TL₃) which are thresholds of charge of the energy storage means PSD associated with the energy prices p₁, p₂, p₃. This threshold of charge constitutes a target value, that is to say that regardless of its initial value, the instantaneous level SEL must aim to meet the value of the threshold of charge TLᵢ.

During the first time cycle C1, the values TL₁, TL₂, TL₃ are initialized arbitrarily by the means M2. Preferably, the initialization of the values of the elements of the second vector V2 is performed in such a way that the value of the i-th element TLᵢ of the second vector V2 is greater than that of the i+1-th element TL,,ᵢ of the second vector V2 for any number i (in the example i is comprised between 1 and 2). It will be seen later that the value of the elements TLᵢ is modified with time. Nevertheless, it has already been pointed out that it is economically more favorable to charge the storage means PSD with energy to a higher level when the price of the energy is low than when it is high. An initialization of the elements of the second vectors V2 which takes account of this observation makes the system efficient more quickly. Here, we consider arbitrarily V2=(TL₁, TL₂, TL₃)=(50, 20, 1).

For the subsequent time cycles, the value of all the elements p₁, p₂, p₃ of the first vector V1 will remain unchanged with respect to the preceding time cycle (except modification of the tariff schedule by the operator). But the value of the elements TL₁, TL₂, TL₃ of the second vector V2 is updated at the end of each time cycle by the means M2. The description of this update is detailed later in the present document.

When the value of one of the elements p₁, p₂, p₃ of the first vector V1 is modified with respect to the preceding time cycle (modification of the tariff schedule by the operator), the means M2 assigns to the value of the i-th element TLᵢ of the second vector V2 the value of the element TLᵢ₋₁ of the second vector V2 for the following time cycle. For example, if the value of p₂ is modified, the value of TL₁ is assigned to the second element TL₂ of the second vector V2.

At this point, the means M2 therefore comprises an association of a first vector V1 comprising 3 elements p₁, p₂, p₃ which are prices of energy supplied by the source and a second vector V2 also comprising 3 elements TL₁, TL₂, TL₃ which are thresholds of charge of the storage means PSD associated with the prices p₁, p₂, p₃.

The means M2 also determines a current threshold of charge QTL_{T1}, QTL_{T2}, QTL_{T3}, QTL_{T4} from said association of the first and the second vector V1, V2 and of the tariff schedule indicating the price q_{T1}, q_{T2}, q_{T3}, q_{T4} of the energy supplied by the source during the current period T₁, T₂, T₃, T₄. For each price q_{Ti} the means M2 assigns to the current threshold of charge QTL_{Ti} the value of the element TL₁, TL₂, TL₃ of the second vector V2 which corresponds (that is to say that it has the same index i) to the element p₁, p₂, p₃ of the first vector V1 equal to the price q_{Ti}.

Thus, here the current threshold of charge (QTL_{T1}, QTL_{T2}, QTL_{T3}, QTL_{T4}) is (50, 20, 5, 20).

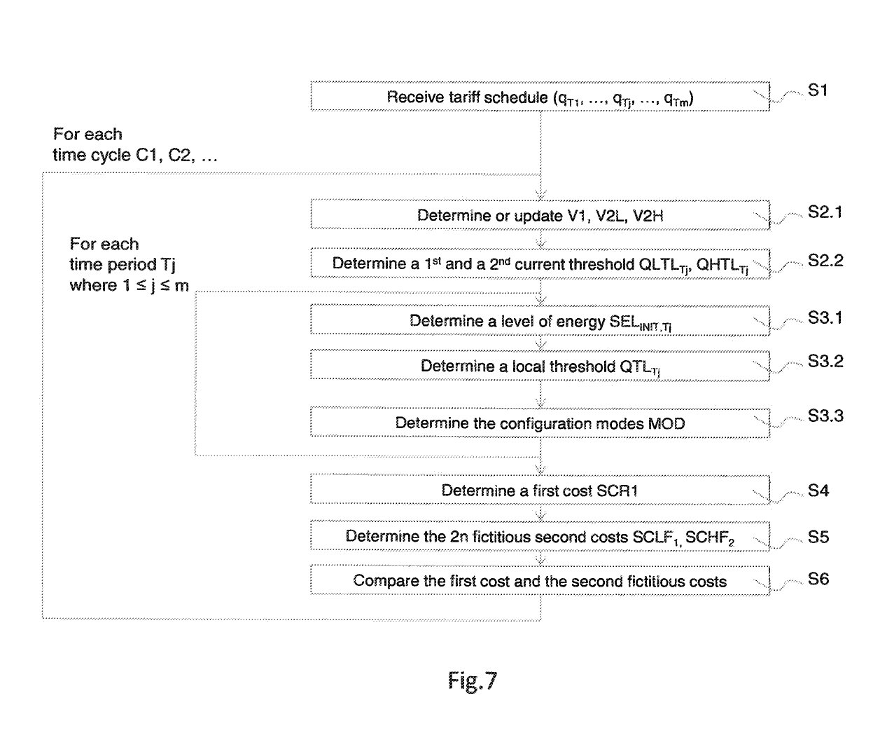

Nota bene: in the flowchart of the method according to the invention corresponding to the second embodiment of the invention which is shown in FIG. 7, the means M2 determines (in step S2.2) a first and a second current threshold (QLTL_{Tj}, QHTL_{Tj}) from a first vector V1 and from two second vectors V2L, V2H then in the following step (step S3.1) it determines a local threshold QTL_{Tj}. In the first embodiment of the invention the first threshold QLTL_{Tj} is equal to the second threshold QHTL_{T}, and the local threshold (QTL-ᵣᵢ) is equal to the current threshold QTL_{T}, of charge.

Advantageously, the means M2 comprises:
a means for receiving the tariff schedule q_{T1}, q_{T2}, q_{T3}, q_{T4},
a means for evaluating the value of the elements p₁, p₂, p₃ of the first vector V1 from said tariff schedule q_{T1}, q_{T2}, q_{T3}, q_{T4} at the start of the time cycles;
a means for evaluating the value of the elements TL₁, TL₂, TL₃ of the second vector V2 at the start of the time cycle C2:
   by an update of the value of the elements TL₁, TL₂, TL₃ when the value of the elements p₁, p₂, p₃ of the first vector V1 is unchanged with respect to the preceding time cycle C1;
   by an initialization of the value of the elements TL₁, TL₂, TL₃ when the value of all the elements p₁, p₂, p₃ of the first vector V1 is modified with respect to the preceding time cycle or during the first time cycle;
   by an assignation of the value of the i-1-th element TLᵢ₋₁ of the second vector V2 to the i-th element TLᵢ of the second vector V2 when the value of the i-th element pᵢ of the first vector V1 is modified with respect to the preceding time cycle.

Advantageously, the means for receiving the tariff schedule receives said tariff schedule directly from the operator PSO by a path distinct from that by which the energy is carried to the local energy transport network DEN, for example an internet connection.

Alternatively, the tariff schedule is sent by the operator PSO to the control device GWY by the same path as the energy is carried to the local network DEN. The tariff schedule can in this case be extracted at the switching device COM and sent by it to the control device GWY. This situation is illustrated in FIG. 1. The tariff schedule is sent by the operator for example in the form of an item of information by power line carrier (PLC).

Advantageously, the means M3 (also shown in FIG. 5) of the control device GWY comprises:
a means for placing the switching device COM in a first mode wherein the energy storage means PSD supplies energy to the client device DCL, when the at least one client device DCL requires energy and when the instantaneous level SEL of energy is strictly greater than the current threshold QTL_{T1}, QTL_{T2}, QTL_{T3}, QTL_{T4} of charge,
a means for placing the switching device COM in a second mode wherein the operator PSO supplies energy simultaneously to the client device DCL and to the energy storage means PSD, when the at least one client device DCL requires energy and when the instantaneous level SEL of energy is less than or equal to the current threshold QTL_{T1}, QTL_{T2}, QTL_{T3}, QTL_{T4} of charge.
a means for placing the switching device COM in a third mode wherein the operator PSO supplies energy exclusively to the client device DCL, when the at least one client device DCL requires energy and when the instantaneous level SEL of energy is equal to the current threshold QTL_{T1}, QTL_{T2}, QTL_{T3}, QTL_{T4} of charge.
a means for placing the switching device COM in a fourth mode wherein the operator PSO supplies energy only to the energy storage means PSD, when the at least one client device DCL does not require energy and when the instantaneous level SEL of energy is less than the current threshold QTL_{T1}, QTL_{T2}, QTL_{T3}, QTL_{T4} of charge;
a means for placing the switching device COM in a fifth mode wherein the operator PSO does not supply energy to the client device DCL and to the energy storage means PSD, when the at least one client device DCL does not require energy and when the instantaneous level SEL of energy is strictly greater than the current threshold QTL_{T1}, QTL_{T2}, QTL_{T3}, QTL_{T4} of charge.

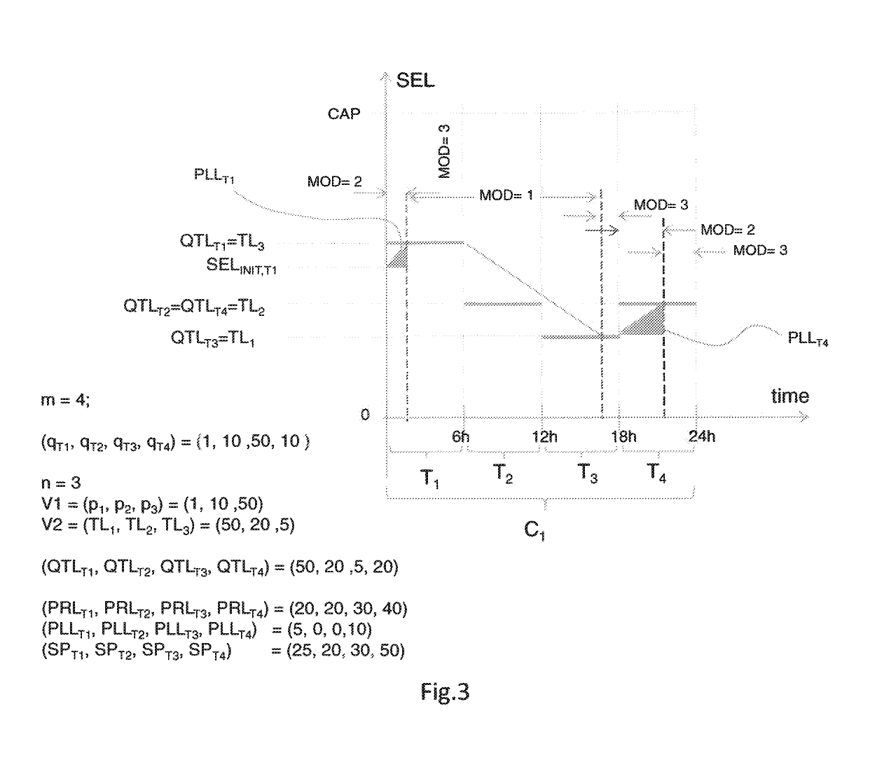

FIG. 3 shows a temporal change in the instantaneous level SEL of energy stored in the storage means PSD when the means M3 of the control device GWY determines and assigns the configuration mode of the switching device COM.

FIG. 3 shows the change in the instantaneous level SEL of energy for the first embodiment of the invention (where a single current threshold of charge is linked to each energy price and therefore to each time period). The current thresholds of charge QTL_{T1}, QTL_{T2}, QTL_{T3}, QTL_{T4} corresponding to the example dealt with are shown by a bold horizontal line covering the duration of a time period T₁, T₂, T₃, T₄.

The instantaneous level SEL of energy can change between the value 0 for which the energy storage means PSD is empty and the value CAP which represents the maximum capacity of the means PSD. For example, the capacity CAP of the energy storage means PSD is equal to 100.

At the start of the first time period T₁, the instantaneous level SEL_{INIT,T1} of the energy storage means PSD is known from the control device GWY as any instantaneous level SEL of energy stored in the storage means PSD. More generally, the value SEL_{INIT},_{T}, is stored in the means M2 of the control device GWY at the start of each time period Tᵢ.

The control device GWY determines and assigns to the device COM one of the configuration modes MOD according to a comparison between an instantaneous level SEL of energy stored in the storage means PSD and the local threshold of charge QTL_{T1}, QTL_{T2}, QTL_{T3}, QTL_{T4} of the current time period T₁, T₂, T₃, T₄.

It is assumed that the client device DCL consumes energy continuously and with a constant level over the four time periods T₁, T₂, T₃, T₄ that is to say that it requires a level of energy per unit time which is constant. Under this assumption, only the first, the second and the third mode can be determined by the control device GWY and assigned to the switching device COM. Other assumptions would naturally lead to the determination of other configuration modes.

In the example shown in FIG. 3, at the start of the time cycle, the value of the instantaneous level SEL of energy is equal to SEL_{INIT},_{Ti} and is less than that of the local threshold of charge QTL_{T1}. Since the client device DCL requires energy, in accordance with the logic of determination of the configuration mode described above, the control device GWY determines the second configuration mode and assigns it to the switching device COM until the instantaneous level SEL of energy reaches the value of the local threshold of charge QTL_{T1}. At this point, the control device GWY determines the third configuration mode, that is to say the operator

PSO exclusively supplies the client device DCL. The energy storage means PSD is not supplied and the instantaneous level SEL of energy is constant until the end of the time period T₁. At the start of the time period T₂, the instantaneous level SEL of energy continuously decreases at a speed which depends on the energy level required by the device DCL per unit time. The increasing slope of the change in the level SEL during the first configuration mode depends on the charge speed of the energy storage means PSD.

During the time period T₂ then the start of the time period T₃, the control device GWY still determines and assigns the first configuration mode to the switching device COM, as the instantaneous level SEL of energy, although it is decreasing, still remains greater than the levels of local threshold of charge (respectively QTL_{T2} over the time period T₂ and QTL_{T3} over the time period T₃): the instantaneous level SEL of energy therefore decreases until the instantaneous level SEL of energy reaches the value of the local threshold QTL_{T3} of charge. At this point, the control device GWY determines the third configuration mode, that is to say that the energy storage means PSD is no longer supplied and that the instantaneous level SEL of energy is constant until the end of the time period T₃.

Finally over the time period T₄, as for the time period T1, the control device GWY determines and assigns the second configuration mode to the switching device COM until the instantaneous level SEL of energy reaches the value of the local threshold QTL_{T4} of charge then it determines and assigns the third configuration mode to the switching device COM.

The bill of the energy consumption can be established as follows from the determination of the energy consumption of the client device DCL and of the storage means PSD:

Over the time periods T₁, T₂, T₃, T₄ the first level PRL_{T1}, PRL_{T2}, PRL_{T3}, PRL_{T4} of energy consumed by the client device DCL is known from the switching device COM at the end of each time period. The information on the energy consumption of the client device DCL can therefore be delivered to the means M1 of the control device GWY at this point.

For example, we consider (PRL_{T1}, PRL_{T2}, PRL_{T3}, PRL_{T4}) =(20, 20, 30, 40). Moreover, the energy consumption of the energy storage means PSD is also known from the switching device COM.

When the configuration mode assigned to the switching device COM is the first mode, the energy storage means PSD is not charged with energy: the latter therefore consumes no energy.

However, when the configuration mode assigned to the switching device is the second mode, the instantaneous level SEL of energy increases which corresponds to a consumption of energy supplied by the operator PSO. This energy consumption of the energy storage means PSD is shown by the grayed area (of triangular shape for our example) found under the change curve for the instantaneous level SEL of energy at the moments when this instantaneous level SEL increases.

Over the time periods T₁, T₂, T₃, T₄ the second level PLL_{T1}, PLL_{T2}, PLL_{T4} of energy consumed by the energy storage means PSD is known from the switching device COM at the end of each time period. The information on the energy consumption of the energy storage means PSD can therefore be delivered to the means M1 of the control device GWY at this point. For the representation in FIG. 3, we consider PLL_{T1}, PLL_{T2}, PLL_{T3}, PLL_{T4}) =(5, 0, 0, 10).

Advantageously, the switching device COM delivers to the control device GWY at the end of each time period T₁, T₂, T₃, T₄ a first level PRL_{T1}, PRL_{T4} of energy supplied to the at least one client device DCL during said time period T₁, T₂, T₃, T₄ and a second level PLL_{T1}, _{PLLT2}, PLL_{T3}, PLL_{T4} of energy charged in the energy storage means PSD supplied by the operator PSO during said time period T₁, T₂, T₃, T₄.

In conclusion, the level SP_{T1}, SP_{T2}, SP_{T3}, SP_{T4} of energy supplied to the system composed of the energy storage means PSD and the client device is equal over the time periods T₁, T₂, T₃, T₄ to (PLL_{T1}+PRL_{T1}, PLL⁻ᵣ₂+PRL_{T2}, PLL_{T3}+PLL_{T4}+PRL_{T4}) =(25, 20, 30, 50).

The real cost of the supply of energy by the source can therefore be established by the means M4 of the control device GWY at the end of each time period T₁, T₂, T₃, T₄ in the form of a first cost using the following formula (CR_{T1}, CR_{T2}, CR_{T3}, CR_{T4}) =(SP_{T1}q_{T1}, SP_{T2}C1_{T2}, SP_{T3}C1_{T3}, SP_{T4}C1_{T4}) =(25, 200, 1500, 500).

Then a means M6 determines a real cost SCR1 of the provision of energy during the time cycle Cl by summing the first costs CR_{T1}, CR_{T2}, CR_{T3}, CR_{T4} in accordance with the following formula SCR1 =CR_{T1} +CR_{T2} +CR_{T3} +CR_{T4} =2225 in our example. Advantageously, the control device GWY comprises:

- a means M4 for evaluating at the end of each time period T₁, T₂, T₃, T₄ a first cost CR_{T1}, CR_{T2}, CR_{T3}, CR_{T4} of the supply by the operator PSO during said time period T₁, T₂, T₃, T₄ of a total level SP_{T1}, SP_{T2}, SP_{T3}, SP_{T4} of energy equal to the sum of the first level PRL_{T1}, PRL_{T2}, PRL_{T3}, PRL_{T4} of energy and of the second level PLL_{T1}, PLL_{T2}, PLL_{T3}, PLL_{T4} of energy supplied by the operator PSO during said time period T₁, T₂, T₃, T₄ where the value of threshold of charge of the storage means PSD considered by said means M3 during said time period T₁, T₂, T₃, T₄ is the value of the current threshold QTL_{T1}, QTL_{T2}, QTL_{T3}, QTL-ᵣₐ of charge;

- a means M6 for summing the m=4 first costs CR_{T1}, CR_{T2}, CR_{T3}, CR_{T4} evaluated at the end of the time cycle to obtain, at the end of said time cycle, a real cost SCR1 of supply of energy by the operator PSO during said time cycle;

In order to reduce the bill of the provision of energy supplied by the operator PSO for subsequent time periods C2, the device GWY evaluates n=3 fictitious costs, that is to say simulated costs, of the provision of energy of the device DCL and of the means PSD over the current time cycle Cl by making assumptions concerning:

- a level PRL_{T1}, PRL_{T2}, PRL_{T3}, PRL_{T4} of energy consumed by the client device DCL identical to that observed during time periods T₁, T₂, T₃, T₄ of the time cycle Cl;

- an instantaneous level SEL_{INIT},_{T}, of charge of the energy storage means PSD at the start of the first time period T₁ of the time cycle Cl which is identical to that determined during the time cycle C1.

The 3 performed simulations correspond to the evaluation of fictitious energy bills in situations which could have been encountered if a value of local threshold of charge corresponding to one of the time periods T₁, T₂, T₃, T₄ differed with respect to the local thresholds of charge QTL_{T1}, QTL_{T2}, QTL_{T3}, QTL_{T4} considered in reality for the time cycle C1.

To do this, the control device GWY also comprises: - a means M5 for evaluating at the end of each time cycle C₁ n=3 fictitious costs SCF1, SCF2, SCF3 of the supply of energy by the operator PSO during said time cycle by the operator PSO to the energy storage means PSD during said time cycle C₁ by considering a level of energy supplied by the operator PSO to the client device DCL during said time periods T₁, T₂, T₃, T₄ is equal to the first level PRL_{T1}, PRL_{T2}, PRL_{T3}, PRL_{T4} of energy, said means M5 simulating a functioning of the means M1, M2, M3 by successively considering n=3 associations (V1, VF2₁); (V1, VF2₂)_{;} (V1, VF2₃) composed of a first vector V1 and of a fictitious second vector

VF2₁, VF2₂, VF2₃ comprising 3 elements (TL₁-F6, TL₂, TL₃) ; (TL₁, TL₂-F6, TL₃), (TL₁, TL₂, TL,-,-F6), where 8 is a positive integer stored in the means M2;

- a means M7 for summing 4 second costs ((CF-ᵣ₁,₁, CF⁻ᵣ₂,₁, CF⁻ᵣ₃,₁, CF⁻ᵣ₄,₁); (CF⁻r1,2, CF_{T2},₂, CF_{T3},₂, CF_{T4},₂), (CF_{T1},₃, CF_{T2},₃, CF_{T3},₃, CF_{T4},₂)) evaluated at the end of each time period T₁, T₂, T₃, T₄ to obtain, at the end of said time cycle, a set of 3 fictitious costs SCF1, SCF2, SCF3 of the supply of energy by the operator PSO during said time cycle.

The means M5 evaluates at the end for each time period T₁, T₂, T₃, T₄ a set of n=3 second costs ((CF⁻ᵣ₁,₁, CF⁻ᵣ₁,₂, CF⁻ᵣ₁,₃); (CF_{T2},₁, CF⁻ᵣ₂,₂, CF_{T2},₃), (CF_{T3},₁, CF_{T3},₂, CF_{T3},₃); (CF⁻ᵣ₄,₁, CF_{T4},₂, CF_{T4},₃)) of the supply of energy by the operator PSO to the means PSD during the time period T₁, T₂, T₃, T₄ by considering a level of energy supplied by the operator PSO to the client device DCL during said time periods T₁, T₂, T₃, T₄ equal to the first level PRL_{T1}, PRL_{T2}, PRL_{T3}, PRL_{T4} of energy;

The evaluations of second costs performed by the means M5 will not be described in detail. These evaluations are in fact identical to those conducted by the means M4 and detailed using FIG. 3 by considering 3 fictitious second vectors VF2₁ VF2₂ VF2₃ instead of the single original vector V2. The evaluations performed by the means M5 aim to establish what the consumption linked to the charging of the storage means PSD would have been if a threshold value of charge different from the value TL, had been considered.

At this point, the control device GWY has on one hand the real cost SCR1 corresponding to the cost of the supply of energy actually billed and on the other hand 3 fictitious costs SCF1, SCF2, SCF3 corresponding to situations not encountered in reality. The control device GWY also comprises:

- a means M8 for comparing the value of the real cost SCR1 and the value of the 3 fictitious costs SCF₁, SCF₂, SCF₃;

Advantageously, the means M2 comprises: - a means for receiving the updates determined by the means M8; - a means for assigning the value TL, +6 to the i-th element of the second vector V2 stored in the means M1 when the value of the fictitious cost SCF, is strictly less than the value of the real cost SCR1;

- a means for assigning the value TL, - .3 to the i-th element of the second vector V2 stored in the means M1 when the value of the fictitious cost SCF, is strictly greater than the value of the real cost SCR1.

Thus, when one of the comparisons between the real cost SCR1 and one of the fictitious costs SCF, makes it possible to show that the bill for the supply of energy would have been lower over the time cycle which has just ended by considering a threshold of charge of the energy storage means PSD of value TL, +6 greater than the current value TL,, then the value TL, -F8 is assigned to the threshold of charge.

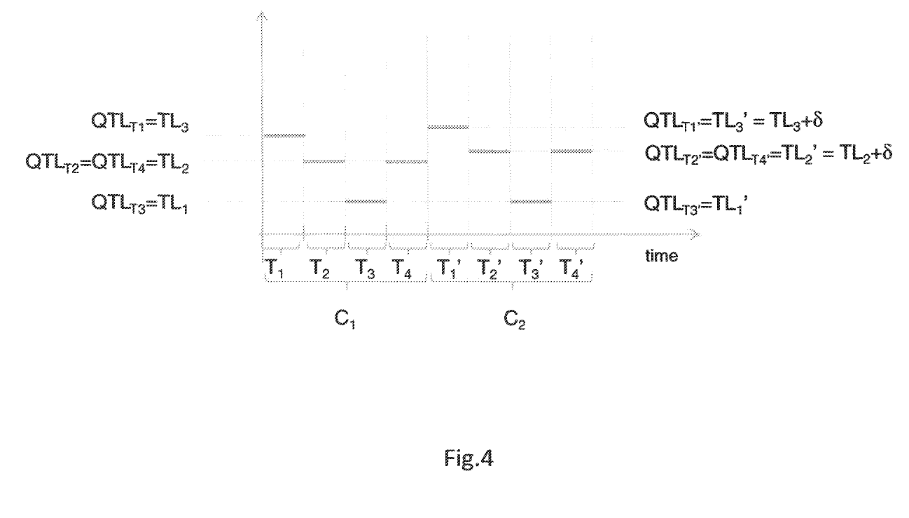

FIG. 4 shows a situation wherein - SCF₃ has a value less than that of SCR1 at the end of the time cycle Cl and where consequently, the value of the threshold of charge TL₃ is modified. This leads in the present case to an increase in the value of the threshold of charge of a value 6 for the time period T1′ of the subsequent cycle C2.

- SCF₂ is less than SCR1 at the end of the time cycle C1 and where consequently, the value of the threshold of charge TL₂ is modified. This leads in the present case to an increase in the value of the threshold of charge of a value 8 for the time periods T2′ and T4′ of the subsequent cycle C2.

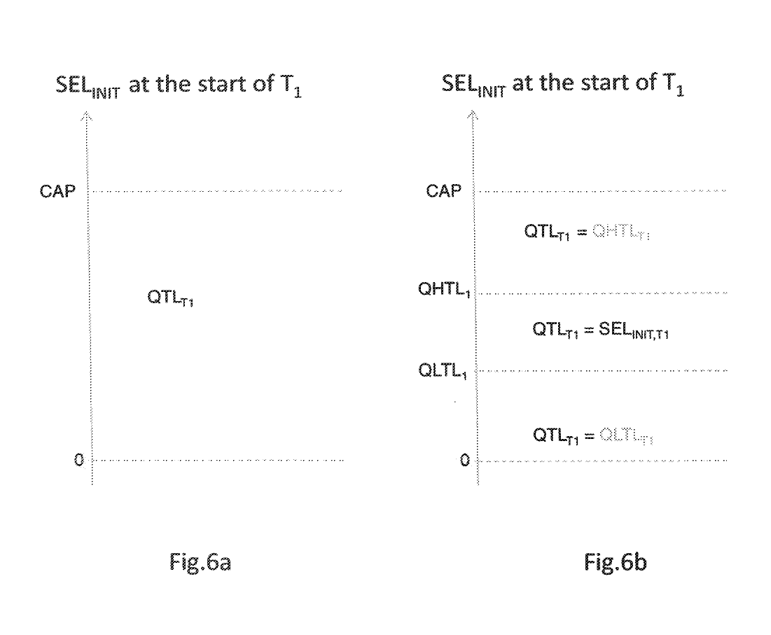

FIG. 6a is a representation, corresponding to the first embodiment of the invention, of the areas of use of the configuration modes, when the device DCL requires energy.

A single threshold of charge QTL_{T1} is associated with the price q-ᵣᵢ of the energy supplied by the operator PSO during the time period Ti.

When the instantaneous level SEL of charge is strictly less than QTL_{T1}, the configuration mode determined by the device GWY is the second mode. When the instantaneous level SEL of charge is strictly greater than QTL_{T1}, the configuration mode determined by the device GWY is the first mode.

When the instantaneous level SEL of charge is equal to QTL_{T1}, the configuration mode determined by the device GWY is the third mode.

Description specific to the second embodiment of the invention wherein two thresholds of charge LTL_{;} and HTLᵢ are associated with a price pᵢ of the energy supplied by the operator PSO.

The detailed description of this second embodiment is very similar to that given in the preceding part of the document. We will rely on the flowchart of the second embodiment of the invention shown in FIG. 7 in order to identify what distinguishes the first and the second embodiment.

A first difference is that the device GWY determines, in a step S2.1, a first and a second vector V2L and V2H rather than a single second vector V2. The first second vector V2L comprises n elements (LTLᵢ, LTL,;,

The second vector V2H comprises n elements (HTLᵢ, HTL,; HTL,,), where LTL, <HTL,.

Subsequently, in a step 2.2 shown in FIG. 7, the means M2 of the device GWY determines a first and a second current threshold (QLTL⁻ᵣᵢ, , QLTL⁻ᵣᵢ, QLTL_{Tm}), (QHTL_{Ti}, QHTL_{Ti}, QHTL_{Tm}) of charge of the storage means PSD associated with each time period T₁, . . . , Tᵢ, Tₘ.

For any j comprised between 1 and m, QLTL_{T}, is less than QHTL_{Ti}. In the first embodiment of the invention, this step 2.2 aims to determine a single threshold (QTL_{T1}, QTL_{TJ}, QTL_{Tm}) of charge of the storage means PSD associated with each time period T₁, . . . , Tᵢ, Tₘ. In a subsequent step 3.2, the means M2 of the device GWY determines a local threshold QTL_{T}, from a comparison between an instantaneous level _{SELINIT,T}, of energy stored in the storage means PSD at the start of the time period Tᵢ and a first and a second current threshold QLTL-ᵣᵢ, QHTL-ᵣᵢ of charge of the storage means PSD associated with each time period Tᵢ. FIG. 6b shows this determination of the local threshold QTL⁻ᵣᵢ.

The first and the second threshold of charge (QLTL⁻ᵣᵢ, QHTL-ᵣᵢ where QLTL⁻ᵣᵢ <QHTL-ᵣᵢ) are associated with the price of the energy supplied during the period T₁.

When the instantaneous level _{SELINIT,T1} of energy stored in the storage means PSD at the start of the time period is strictly less than QLTL-ᵣᵢ, the local threshold

QTL_{T1} determined by the device GWY is the first threshold QLTL-ᵣᵢ of charge.

When the instantaneous level SEL_{INIT},_{T1} is strictly greater than QHTL-ᵣᵢ, the local threshold QTL_{T1} determined by the device GWY is the second threshold QHTL-ᵣᵢ of charge. When finally the instantaneous level SEL_{INIT},_{T1} of charge is greater than or equal to QLTL-ᵣᵢ and less than or equal to QHTL-ᵣᵢ the local threshold QTL_{T1} determined by the device GWY is the instantaneous level SEL_{INIT},_{Ti}.

Step S3.3 is identical for the first and the second embodiment of the invention. When the device DCL requires energy over the whole period this step can lead to at most two modifications of the configuration mode: in a time period T, the device

GWY can successively assign to the device COM the second mode then third mode or the first mode then the third mode during said time period T.

Step S4 for evaluating a real cost SCR1 of the supply by the operator PSO of a total level SP-ᵣ₁, . . . , SP_{T},, SP_{Tm} of energy is identical for the first and the second embodiment of the invention.

Step S5 which relates to the evaluation of fictitious costs differs for the first and the second embodiment of the invention. The paragraph which follows will present these differences.

A first difference is in the number of fictitious costs evaluated: 2n for the second embodiment and n for the first embodiment.

The 2n fictitious costs SCLF₁, SCLF,, SCHFᵢ, SCHF,, SCHF,-, result from 2n simulations performed by the device GWY of the cost of a supply of energy by the operator PSO to the system device DCL and means PSD.

The assumptions made to conduct these simulations are as follows:

1. The instantaneous level SEL_{INIT},_{T1} of energy at the start of the first time period T₁ is identical for all the simulations and to the value actually measured at this time. The value _{SELINIT,Ti} is stored during the time cycle for this purpose. 2. The level of energy supplied by the operator PSO to the client device DCL during said time periods T₁, . . . , Tᵢ, Tₘ is equal to the first level PRL_{T1},

PRL_{Ti}, PRL_{Tm} of energy. The first two assumptions above are also made for the first embodiment of the invention. In step S5 the means M5 simulates a functioning of the means M1, M2, M3 by successively considering 2n associations (V1, V2LF2,, V2LF2,), (V1, V2HF2,, V2HF2,) composed of the first vector V1, and of a fictitious second vector VLF2,, VHF2, where the fictitious second vector VLF2, comprises n elements LTLᵢ, LTL,+6, LTL,-, and the fictitious second vector VLF2, comprises n elements HTL₁, . . . , HTL,-F6, HTL, where 8 is a positive integer stored in the means M2.

This step is similar to that implemented in the first embodiment of the invention: in the second embodiment, it is implemented twice to obtain the 2n fictitious costs.

The main advantage of the different embodiments of the invention presented above is to reduce the amount of the bill for the provision of energy for the dwelling unit which is equipped with it . . . while freeing the occupant or occupants from the constraints linked to the time of the consumption of the energy, that is to say from the constraints linked to the time of the start-up of the household equipment. In particular, these embodiments of the invention eliminate the need for start-up programming systems on household equipment : washing machine, oven pyrolysis or other which can also lead to a reduction in purchase price and a better reliability.

These embodiments also have the advantage of reducing the need for energy production means. An operator responsible for producing the energy must size its energy production means from estimations of the maximum energy supply requirement. The embodiments described make it possible to smooth the energy supply time using a tariff incentive which has the result of reducing the level of the energy consumption peak.

A third advantage of these embodiments lies in the simplicity of their deployment in a domestic electrical network of an individual dwelling unit. The embodiments of the invention essentially comprise or implement an energy storage means PSD, a switching device COM and a control device GWY. It has been mentioned above that it is increasingly common these days for dwelling units to comprise such energy storage means PSD, and in the future the presence of these means will probably rapidly increase in connection with the development of electric vehicles. The device COM provides a configurable switch function which can be easily integrated into the path of the energy leading to the local energy network, for example in a smart grid or even at the energy storage means PSD. The device GWY which configures the mode of the device COM can be integrated for example either into an access gateway of a local communication network of the dwelling unit having means for storing information and means of calculation or into the same smart grid.

Other advantages of this embodiment stem from its automatic and adaptive nature already mentioned above. Finally, another advantage of this embodiment is its ability to protect the private lives of individual consumers from intrusive observations which the energy supply operator would be likely to make. In fact, the new smart grids are adapted to supply a report in real time on the level of energy supplied to the dwelling unit which is equipped with it. By decorrelating the start-up times of the equipment of the local network and the times when the energy is supplied to the local network, the embodiment hides from the operator a part of the information on the lifestyle of the occupants of the dwelling unit. For example, it makes it impossible to detect human presence in an individual dwelling unit on the basis of a single item of information on the supply of electrical energy of the dwelling unit, since it may be the purpose of this supply of energy to increase the level of charge of the energy storage means and not to respond to the consumption of a device of the local network.

The second embodiment of the invention is well adapted to the situations where the energy storage means PSD has an efficiency less than 100% (both for storing energy and/or for restoring it) as the existence of the first and the second threshold of charge makes it possible to give priority to the situation where the client device DCL is supplied directly by the operator and without loss. However, it has the disadvantage of being more costly in terms of the number of calculations since it requires 2n evaluations of fictitious prices and 2n comparisons of prices when only n evaluations of fictitious prices and n comparisons of prices are necessary for the first embodiment. Advantageously, the means M3 comprises: - a means for placing the device COM in a first mode wherein the energy storage means PSD supplies energy to the client device DCL, when the client device DCL requires energy and the instantaneous level SEL of energy is strictly greater than the local threshold QTL⁻ᵣᵢ, ., QTL_{Ti}, QTL⁻ᵣₘ;

- a means for placing the device COM in a second mode wherein the operator PSO supplies energy simultaneously to the client device DCL and to the energy storage means PSD, when the client device DCL requires energy and when the instantaneous level SEL of energy is strictly less than the local threshold QTL⁻ᵣᵢ, , QTL_{Ti}, QTL⁻ᵣₘ;

- a means for placing the device COM in a third mode wherein the operator PSO supplies energy exclusively to the client device DCL, when the client device DCL requires energy and when the instantaneous level SEL of energy is equal to the local threshold QTL⁻ᵣᵢ, QTL⁻ᵣᵢ, QTL⁻ᵣₘAdvantageously, the means M2 comprises:

- a means for receiving the tariff schedule n -,T1, q-rᵢ, , CiTm of the operator

PSO;

- a means for evaluating, at the start of each time cycle C1, C2, the value of the elements pᵢ, p,, pₙ of the first vector V1 from said tariff schedule q_{Ti}, q_{Ti}, q_{Tm} and the value of the elements LTLᵢ, LTL,, HTLᵢ, HTL,,

HTL,, of the second vectors V2L, V2H: o by an initialization of the value of the elements of the second vectors V2L, V2H when the value of all the elements pᵢ, p,, pₙ of the first vector V1 is modified with respect to the preceding time cycle or during a first time cycle C1; o by an assignation of the value of the i-1-th element LTL,_{—i} HTL,_{—i} of the second vector V2L, V2H to the i-th element LTL,_{—i} , HTL,_{—i} of the second vector V2L, V2H when the value of the i-th element p, of the first vector V1 is modified with respect to the preceding time cycle; o by an update of the value of the elements of the second vectors V2L, V2H when the value of all the elements pᵢ, p,, pᵢ, of the first vector V1 is unchanged with respect to the preceding time cycle. Advantageously, the control device GWY also comprises: - a means M4 for evaluating at the end of each time period Tᵢ, Tᵢ, Tₘ a first cost CR-ᵣ₁, , CR⁻ᵣᵢ, -,CR_{Tm} of the supply by the operator PSO during said time period Tᵢ, T_{J}, Tₘ of a total level SP-ᵣ₁, , SP⁻ᵣᵢ, SP_{Tm} of energy equal to the sum of the first level of energy PRL_{T1}, . . . , PRL⁻ᵣᵢ, PRL-ᵣₘ and the second level PLL-ᵣ₁, PLL⁻ᵣᵢ, PLL-ᵣₘ of energy;

- a means M5 for evaluating two sets of n second costs CLF⁻ᵣᵢ,ᵢ, CLF-ᵣ₁,_{;}, . . . , CLF-ᵣᵢ,ₙ, CLF_{T},,ᵢ, CLF_{T},,,, CLF_{T},,ₙ, , CLF⁻ᵣₘ,,, , CLF⁻ᵣₘ,ₙ, CHF-ᵣᵢ,ᵢ, CHF⁻ᵣ₁,, . . . , CHF⁻ᵣᵢ,ₙ, . . . , CHF-ᵣᵢ,ᵢ, CHF⁻ᵣ, . . . , CHF⁻ᵣ,,ₙ, . . . , CHF⁻ᵣₘ,ᵢ, ,

CHF_{Tm},,, CHF_{Tm},ₙ of the supply of energy by the operator PSO to the energy storage means PSD during said time period T₁, . . . , Tᵢ, Tₘ by considering a level of energy supplied by the operator PSO to the client device DCL during said time periods T₁, . . . , Tᵢ, Tₘ equal to the first level PRL-ᵣ₁, PRL-ᵣᵢ, PRL_{Tm} of energy, said means M5 simulates a functioning of the means M1, M2, M3 by successively considering 2n associations V1, V2LF2,, V2LF2,, V1, V2HF2,, V2HF2, composed of the first vector V1, and of a fictitious second vector VLF2,,VHF2, where the fictitious second vector VLF2, comprises n elements LTLᵢ, LTL,-F6, LTLₙ and the fictitious second vector VLF2, comprises n elements HTLᵢ, HTL,-F6, HTLₙ, where .3 is a positive integer stored in the means M2;

- a means M6 for summing the m first costs CR_{T1}, . . . CR_{TJ}, . . . ,CR_{Tm} evaluated at the end of the time cycle to obtain a real cost SCR1 of supply of energy by the operator PSO during said time cycle;

- a means M7 for summing said m seconds costs CLF⁻ᵣᵢ,ᵢ, . . . , CLF⁻ᵣᵢ,ₙ, . . . , CLF-ᵣᵢ,ᵢ, CLF-ᵣᵢ, . . . , CLF_{T},,ₙ, , CLF-ᵣₘ,ᵢ, CLF⁻ᵣₘ,ₙ,

CHF-ᵣᵢ,ᵢ, CHF⁻ᵣ₁,, . . . , CHF⁻ᵣᵢ,ₙ, . . . , CHF-ᵣᵢ,ᵢ, CHF⁻ᵣ, . . . , , CHF⁻ᵣ,,ₙ, . . . . , CHF⁻ᵣₘ,ᵢ, , CHF_{Tm},,, CHF_{Tm},ₙ evaluated at the end of each time cycle C₁, C₂ to obtain at least two sets of n fictitious costs SCLF₁, SCLF,, SCLFₙ, SCHFᵢ, SCHF,, SCHFₙ of the supply of energy by the operator PSO during said time cycle; - a means M8 for comparing at the end of the time cycle the value of the real cost SCR1 and the value of each of the fictitious costs SCLF₁, SCLF,, SCLFₙ, SCHFᵢ, SCHF,, SCHFₙ and delivering results RESLᵢ, RESLᵢ, RESLₙ, RESHᵢ, RESH,, RESHₙ of said comparisons. Advantageously, the means M2 also comprises: - a means for receiving said results of said comparisons delivered by the means

M8;

- a means for adding the value 6 to the value of the i-th element of the second vector V2L, V2H stored in the means M1 when the result RESL,, RESH, establishes that the value of the fictitious cost SCLF,, SCHF, is strictly less than the value of the real cost SCR1; - a means for subtracting the value 8 from the value of the i-th element of the second vector V2L, V2H stored in the means M1 when the result RESL,, RESH, establishes that the value of the fictitious cost SCLF,, SCHF, is strictly greater than the value of the real cost SCR1. Advantageously, the means M3 also comprises:

- a means for placing the device COM in a fourth mode wherein the operator PSO supplies energy only to the energy storage means PSD, when the client device DCL does not require energy and while the instantaneous level SEL of energy is strictly less than the local threshold QTL⁻ᵣᵢ, QTL⁻ᵣₘ; - a means for placing the device COM in a fifth mode wherein the operator PSO does not supply energy to the client device DCL and to the energy storage means PSD, when the client device DCL does not require energy and when the instantaneous level SEL of energy is greater than or equal to the local threshold QTL⁻ᵣᵢ, , QTL_{Tm}Although the invention has been described in relation to two particular embodiments, it is obvious that it is in no way restricted and that it comprises all the technical equivalents of the means described together with their combinations if the latter fall within the scope of the invention.

1. System for managing the supply of energy of a client device connected to an energy transport network, said system comprising a switching device connected to said network, the client device being able to be supplied with energy via the switching device, said network receiving energy according to a tariff schedule (q_{T1}, . . . , q_{Tj}, . . . , q_{Tm}) according to which the time is decomposed into successive time intervals, each time interval being divided into a number m greater than or equal to 2 of successive time periods during each of which said energy is billed at a price corresponding to said period.
said system comprising an energy storage means connected to said network via the switching device,
wherein the switching device is able to be configured according to:
a first configuration mode wherein the energy storage means supplies energy to the client device; or
a second configuration mode wherein the energy received simultaneously by the client device and the energy storage means; or
a third configuration mode wherein the energy is received exclusively by the client device;
the system also comprising a control device comprising means for comparing an instantaneous level of energy stored in the storage means and a local threshold of charge of the storage means associated with each time period and means for determining and assigning to the switching device a configuration mode from among the first, second and third configuration modes according to the result of said comparison,

2. System according to claim 1, wherein the control device comprises means for comparing the instantaneous level of energy stored in the storage means at the start of the time period and a first and a second current thresholds of charge of the storage means associated with each time period and means for determining the local threshold from the result of said comparison.

3. System according to claim 1, wherein the means for determining and assigning are able to determine and assign to the switching device when the client device requires energy:
the first mode when the instantaneous level of energy is strictly greater than the local threshold;
the second mode when the instantaneous level of energy is strictly less than the local threshold ;
the third mode when the instantaneous level of energy is equal to the local threshold.

4. System according to claim 1, wherein the switching device is able to deliver to the control device at the end of each time period, a first level of energy received by the client device and a second level of energy received by the energy storage means during said time period.

5. System according to claim 1, wherein the control device is adapted to determine a first vector of n elements which correspond to the energy prices of the tariff schedule classified according to an increasing order, and two second vectors of n elements which are thresholds of charge of the storage means associated with the prices p₁, . . . , pᵢ, . . . , pₙ, where i is an integer comprised between 1 and n, the control device also being adapted to determine the first and the second current thresholds from the first and second vectors and from said tariff schedule.

6. System according to claim 5, wherein the control device comprises means for updating, at the end of each time interval, the value of the elements of the two second vectors from a result of comparison between a real cost of the supply of a total level of energy and 2n fictitious costs, where the total level is equal to the sum of the first level of energy and the second level of energy during said time periods and where the fictitious costs result from 2n simulations performed by the control devices of the cost of a supply of energy to said system, by considering a level of energy received by the client device during said time periods equal to the first level of energy and by successively considering 2n associations (V1, V2LF2ᵢ, V2LF2ᵢ), (V1, V2HF2ᵢ, V2HF2ᵢ) composed of the first vector V1 and of a fictitious second vector VLF2ᵢ, VHF2ᵢ where the fictitious second vector VLF2ᵢ comprises n elements LTL₁, . . . , HTLᵢ+δ, . . . , HTLₙ, and the fictitious second vector VHF2ᵢ comprises n elements HTL₁, . . . , HTLᵢ+δ, . . . , HTLₙ, where d is a positive integer stored in the control device.

7. System according to claim 1, wherein the switching device is also able to be configured according to:
a fourth mode wherein the energy is supplied only to the energy storage means;
a fifth mode wherein no energy is supplied to the system;
and wherein, when the client device does not require the energy, the means for determining and assigning of the control device are able to determine and assign to the switching device :
the fourth mode if the instantaneous level of energy is strictly less than the local threshold;
the fifth mode if the instantaneous level of energy is greater than or equal to the local threshold.

8. Control device for a system for managing the supply of energy of a client device connected to an energy transport network, the client device being able to be supplied with energy via a switching device connected to said network, said network receiving energy to a tariff schedule according to which the time is decomposed into successive time intervals, each time interval being divided into a number m greater than or equal to 2 of successive time periods during each of which said energy is billed at a price corresponding to said period, wherein it comprises:
a first means for receiving from the switching device at the end of each time period a first level of energy supplied to the client device and a second level of energy supplied to the energy storage means during said time period;
a second means which comprises an association of a first vector of n elements corresponding to the energy prices of the tariff schedule classified according to an increasing order and two second vectors each comprising n elements which are thresholds of charge of the storage means associated with prices, where i is an integer comprised between 1 and n, said second means also being configured to determine a first and a second current threshold of charge from said association and from said tariff schedule, said second means also being adapted to determine a local threshold of charge of the storage means from a comparison between an instantaneous level of energy stored in the energy storage means at the time period start and said first and second current thresholds associated with said time period;
a third means for determining and assigning in real time a configuration mode to the switching device on the basis of a comparison between:
the instantaneous level which said third means is able to receive in real time from said storage means; and
the value of the local threshold associated with said time period.

9. Control device according to claim 8, wherein the third means comprises:
a means for placing the switching device in a first configuration mode wherein the energy storage means supplies energy to the client device, when the client device requires energy and the instantaneous level of energy is strictly greater than the local threshold;
a means for placing the switching device in a second configuration mode wherein energy is supplied simultaneously to the client device and to the energy storage means, when the client device requires energy and when the instantaneous level of energy is strictly less than the local threshold;
a means for placing the switching device in a third configuration mode wherein energy is supplied exclusively to the client device, when the client device requires energy and when the instantaneous level of energy is equal to the local threshold.

10. Controi device according to claim 8, wherein the second means comprises:
a means for receiving the tariff schedule;
a means for evaluating, at the start of each time interval, the value of the elements of the first vector from said tariff schedule and the value of the elements of the second vectors:
by an initialization of the value of the elements of the second vectors when the value of all the elements of the first vector is modified with respect to the preceding time interval or during a first time interval;
by an assignation of the value of the i-1-th element of the second vector to the i-th element of the second vector when the value of the i-th element pᵢ of the first vector is modified with respect to the preceding time interval;
by an update of the value of the elements of the second vectors when the value of all the elements of the first vector is unchanged with respect to the preceding time interval.

11. Control device according to claim 10, also comprising:
a fourth means for evaluating at the end of each time period a first cost of the supply of energy during said time period of a total level of energy equal to the sum of the first level of energy and the second level of energy;
a fifth means for evaluating two sets of n second costs of the supply of energy to the energy storage means during said time period by considering a level of energy supplied to the client device during said time periods equal to the first level of energy, said fifth means simulating a functioning of the first, second and third means by successively considering 2n associations (V1, V2LF2, V2LF2ₗ, V1, V2HF2ᵢ, V2HF2ᵢ) composed of the first vector, and of a fictitious second vector VLF2ₗ, VHF2) where the fictitious second vector VLF2 comprises n elements LTL₁, . . . , LTLₗ+δ, . . . , LTLₙ and the fictitious second vector VHF2ᵢ comprises n elements HTL₁, . . . , HTLₗ+δ, . . . , HTLₙ , where δ is a positive integer stored in the second means M2;
a sixth means for summing the m first costs evaluated at the end of the time interval to obtain a real cost of supply of energy during said time eye interval;
a seventh means for summing said m seconds costs evaluated at the end of each time interval to obtain at least two sets of n fictitious costs of the supply of energy during said time interval;
an eighth means for comparing at the end of the time interval the value of the real cost and the value of each of the fictitious costs of said comparisons.

12. Control device according to claim 11, wherein the second means also comprises:
a means for receiving said results of said comparisons delivered by the eighth means;
a means for adding the value δ to the value of the i-th element of the second vector stored in the first means when the result establishes that the value of the fictitious cost is strictly less than the value of the real cost;
a means for subtracting the value δ from the value of the i-th element of the second vector stored in the first means when the result establishes that the vale of the fictitious cost is strictly greater than the value of the real cost.

13. Control device according to claim 8, wherein the third means also comprises:
a means for placing the switching device in a fourth mode wherein the energy is supplied only to the energy storage means, when the client device does not require energy and while the instantaneous level of energy is strictly less than the local threshold;
a means for placing the switching device in a fifth mode wherein no energy is supplied to the client device and to the energy storage means (PSD), when the client device does not require energy and when the instantaneous level of energy is greater than or equal to the local threshold.

14. Method for managing the supply of energy of a client device connected to an energy transport network, the client device being able to require energy via a switching device connected to said network, said network receiving energy via said switching device according to a tariff schedule according to which the time is decomposed into successive time intervals, each time interval being divided into a number m greater than or equal to 2 of successive time periods during each of which said energy is billed at a price corresponding to said period, an energy storage means being connected to said network via the switching device configured according to a first mode wherein the energy storage means supplies energy to the client device or a second mode wherein energy is supplied simultaneously to the client device and to the energy storage means, or a third mode wherein energy is supplied exclusively to the client device, wherein, at the control device, it comprises the steps of
receiving said tariff schedule;
continuously and in real time, receiving from the energy storage means an instantaneous level of energy stored in said energy storage means;
evaluating a number n of elements of a first vector from said tariff schedule and at the start of each time interval determining n elements of two second vectors associated with n elements of the first vector;
determining a first and a second current thresholds of charge of the storage means for said current period from the tariff schedule and from the association;
at each time period
determining an instantaneous level of energy at the start of the time period;
determining a local threshold of charge of the storage means from a comparison between the instantaneous level of energy stored in the storage means at the start of the time period and the first and second current thresholds of charge associated with the time period;
continuously and in real time, determining and assigning a configuration mode to the switching device in such a manner that the instantaneous level meets the local threshold.

15. Method according to claim 14, also comprising steps of:
evaluating the real cost of the supply of energy during said time interval covering said time periods;
evaluating 2n fictitious costs SGL of the supply of energy during said time interval covering said time periods from an evaluation of two sets of n second costs of the supply of energy to the energy storage device during said time period by considering a level of energy supplied to the client device during said time periods equal to the first level of energy, by successively considering 2n associations composed of the first vector and of a fictitious second vector VLF2ₗ, VHF2ᵢ where the fictitious second vector VLF2 comprises n elements LTL₁, . . . , LTLᵢ+δ, . . . , LTLₙ and the fictitious second vector VHF2ᵢ comprises n elements HTL₁, . . . , HTLᵢ+δ,, . . . , HTLₙ, where δ is a positive integer stored in the control device;
comparing at the end of the time interval the value of the real cost and the value of each of the fictitious costs;
updating the value of the elements of the second vectors stored in the control means according to the results of said comparisons.
